(19) United States
(12) Patent Application Publication
(10) Pub. No.: US 2011/0179912 A1
(43) Pub. Date: Jul. 28, 2011

(54) HAND TOOL

(76) Inventor: CHIA-HO LIN, TAICHUNG COUNTY (TW)

(21) Appl. No.: 12/980,937

(22) Filed: Dec. 29, 2010

(30) Foreign Application Priority Data
Jan. 22, 2010 (TW) 099201287

(51) Int. Cl. B25B 13/46

(52) U.S. Cl. 81/60

(57) ABSTRACT

A hand tool is revealed. Inner plates are clipped between two outer plates. An insertion hole of the inner plate is corresponding to a fixing hole of the outer plate. A ratchet connecting plug is mounted in clamping holes of each outer plate. By a fixing member penetrating each fixing hole, the assembling of the outer plates, inner plates and the ratchet connecting plug is completed. The convenient assembly is attained. Moreover, the inner and outer plates form a handle with required thickness. The handle is convenient to hold and work for fastening screw fasteners. Furthermore, an ejector disposed on the ratchet connecting plug is used to push the screw fastener off the ratchet connecting plug quickly for improving the working efficiency. Each of two ends of the outer plate can be assembled with one ratchet connecting plug so that users can choose one according to practical needs.

### BACKGROUND OF THE INVENTION

1. Field of the Invention

The present invention relates to a hand tool, especially to a hand tool that is easy assembled and having two ends assembled with a ratchet connecting plug for meeting users' requirements.

2. Description of Related Art

In recent hundred years, hand tools have been developed rapidly and become one of essentials for performing our works. Modern people need tools with compact design and portability. As to users need to carry or use various tools, the working efficiency is improved once the tool provides light-weighted and easy-to-use features. According to utility, hand tools are divided into different groups. For example, the most common wrench tools include open wrenches, socket wrenches, ring ratchet wrenches with at least one hexagonal hole or dodecagonal hole, etc. Users pick up proper tools to use according to their needs.

The above ratchet wrench includes a ratchet set and a handle. However, while assembling the ratchet set with the handle, the assembly is difficult due to complicated components of the ratchet set.

In order to solve above problems, there is a need to provide a new design of the device.

### SUMMARY OF THE INVENTION

Therefore it is a primary object of the present invention to provide a hand tool includes outer plates and inner plates, assembled with each other to form a handle with feature of easy assembly. Moreover, the handle, formed by inner plates and outer plates, with the thickness required is easy to hold and operate for fastening screw fasteners. Furthermore, each of two ends of the outer plate can be assembled with a ratchet connecting plug. Thus users can choose one to use according to practical needs.

In order to achieve above object, a hand tool of the present invention primarily includes outer plates, inner plates and at least one ratchet connecting plug. One end of the outer plate is arranged with a clamping hole for mounting the ratchet connecting plug. A plurality of fixing holes is also set at the outer plate. Each fixing hole is mounted with a fixing member so as to connect with the inner plate. One end of the inner plate is arranged with a locking hole for receiving a first elastic part of the ratchet connecting plug. An insertion hole corresponding to the fixing hole of the outer plate is set on the inner plate. The fixing member penetrates the insertion hole. The ratchet connecting plug includes a locking block engaged with one side thereof. The first elastic part is clipped between the other side of the locking block and the locking hole of the inner plate.

The ratchet connecting plug is disposed with an ejector. By being pressed, the ejector pushes the screw fastener off the ratchet connecting plug quickly. Thus the working efficiency is enhanced significantly.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein FIG. 1 is an explosive view of an embodiment according to the present invention;

FIG. 2 is an assembly view of an embodiment according to the present invention;

FIG. 3 is a top view of an assembled embodiment according to the present invention;

FIG. 4 is an assembly view of another embodiment according to the present invention;

FIG. 5 is a top view of another assembled embodiment according to the present invention.

### DETAILED DESCRIPTION OF THE PREFERRED EMBODIMENT

Refer to FIG. 1, an embodiment of a hand tool according to the present invention is revealed. The hand tool includes a plurality of outer plates 1, a plurality of inner plates 2 and a ratchet connecting plug 3.

One end of the outer plate 1 is disposed with a clamping hole 11 for mounting the ratchet connecting plug 3. A plurality of fixing holes 12 is arranged at the outer plate 1. Each fixing hole 12 is corresponding to and arranged with a fixing member 13 so as to fix and connect with the inner plate 2 or a locking block 31 of the ratchet connecting plug 3.

One end of the inner plate 2 is arranged with a locking hole 21 for receiving a first elastic part 32 of the ratchet connecting plug 3. An insertion hole 22 corresponding to the fixing hole 12 of the outer plate 1 is disposed on the inner plate 2. The fixing member 13 passes through the insertion hole 22 to be fixed by the insertion hole 22.

A locking block 31 is engaged with a side of the ratchet connecting plug 3 so as to limit rotation direction of the ratchet connecting plug 3 while the first elastic part 32 is clipped between the other side of the locking block 31 and the locking hole 21 of the inner plate 2 so that the locking block 31 and the ratchet connecting plug 3 are meshed with each other closely. A receiving part 33 is formed above the ratchet connecting plug, around an axis of the ratchet connecting plug and an ejector 34 penetrates the receiving part 33. The top of the ejector 34 is connected with a button 341. After the button 341 being pressed, a screw fastener sleeved and connected with the ratchet connecting plug 3 is ejected. Moreover, a second elastic part 35 is clamped between the button 341 of the ejector 34 and the receiving part 33 for providing elastic force required for ejection.

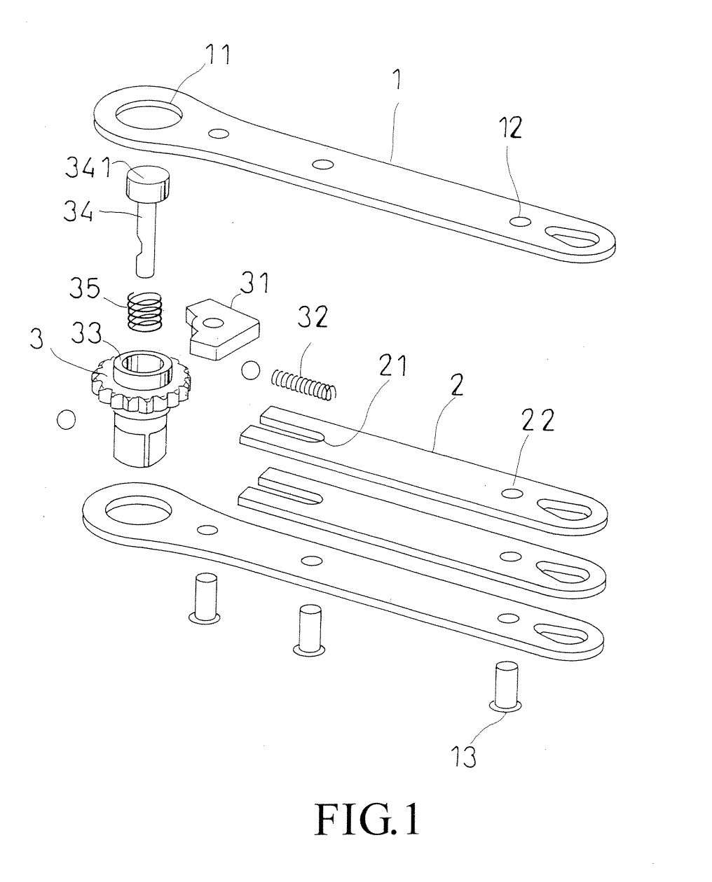

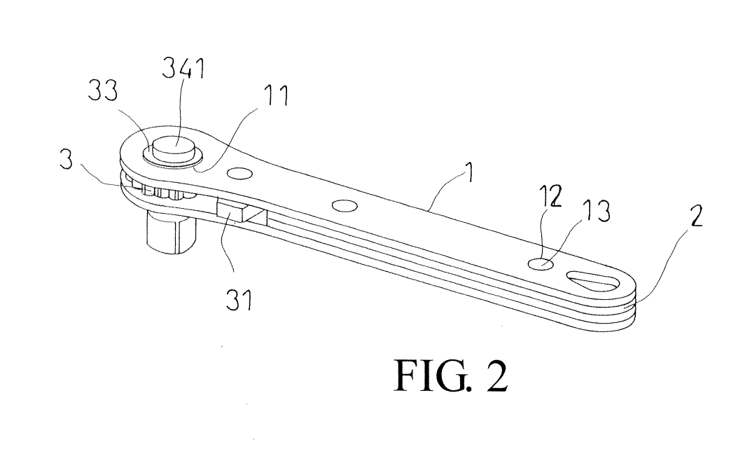

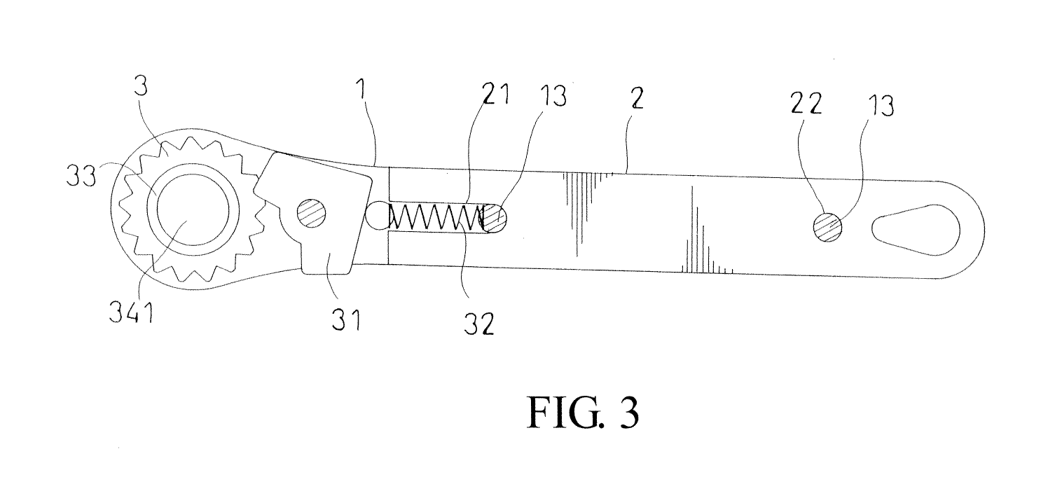

While assembling, refer from FIG. 1 to FIG. 3, the plurality of the inner plates 2 is arranged between two outer plates 1 so as to get the required thickness. The insertion hole 22 of the inner plate 2 is corresponding to the fixing hole 12 of the outer plate 1 while the ratchet connecting plug 3 is assembled with the clamping hole 11 of each outer plate 1. The locking block 31 is disposed correspondingly to the fixing hole 12 beside the clamping hole 11. The first elastic part 32 is mounted in the locking hole 21 of the inner plate 2. Then the fixing member 13 is fastened with (into) each fixing hole 12. The fixing member 13 passes through the locking block 31 or the insertion hole 22 to be fixed on the fixing hole 12 of the other outer plate 1. Thus the assembling among the outer plate 1, the inner plate 2 and the ratchet connecting plug 3 is completed. The assembling is easy and convenient. Moreover, a handle with required thickness is formed by the outer plates 1 and the inner plates 2. The handle is easy to hold and operate for fastening screw fasteners. After completing the fastening, the button 341 of the ejector 34 is pressed so that the ejector 34 pushes against the screw fastener sleeved with the ratchet connecting plug 3. Thus the ratchet connecting plug 3 and the screw fastener are separated with each other quickly. Therefore, the working efficiency is dramatically improved.

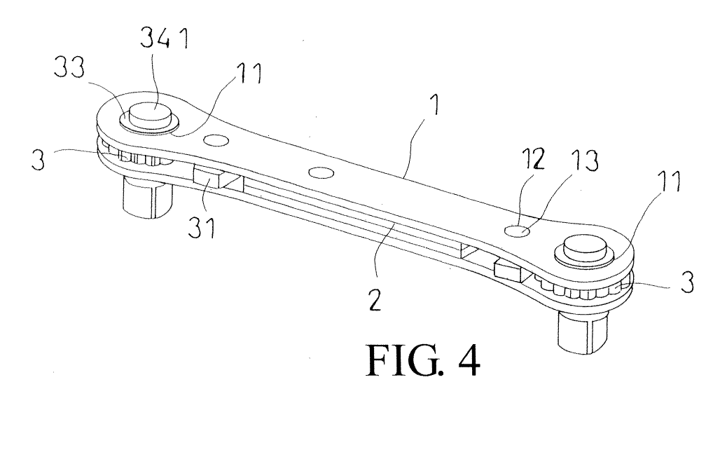

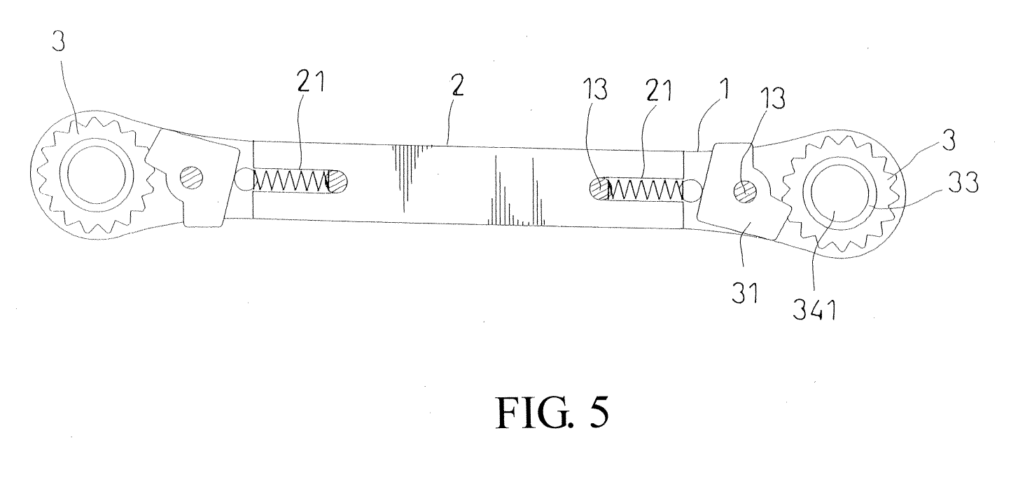

Refer to FIG. 4 and FIG. 5, another embodiment is disclosed. The difference between this embodiment and the above one is in that each of two ends of an outer plate 1 of this embodiment is arranged with a clamping hole 11 so as to assemble with a ratchet connecting plug 3. Thus users can choice one to operate according to their needs.

Compared with the structure available now, the present invention has following advantages:

1. The present invention includes a plurality of inner plates clipped between the two outer plates to be assembled with the ratchet connecting plug, used as a handle. Thus easy and convenient assembly is assured. The handle having inner and outer plates with required thickness is easy to hold and operate for fastening screw fasteners.

2. The ratchet connecting plug is disposed with the ejector so as to push the screw fastener off the ratchet connecting plug quickly by pressing. Thus the working efficiency is increased significantly.

3. Each of two ends of the outer plate of the present invention can be arranged with a clamping hole for mounting the ratchet connecting plug. Users can choose one of the clamping holes to use according to practical needs.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A hand tool comprising:
at least one inner plate;
outer plates fixed on an outer side of the inner plate;
a ratchet connecting plug arranged between the outer plates and engaged with one side of a locking; and
a first elastic part clipped between the other side of the locking block and the inner plate.

2. The device as claimed in claim 1, wherein the ratchet connecting plug is disposed with an ejector while a second elastic part is clamped between the ejector and the ratchet connecting plug.

3. The device as claimed in claim 2, wherein the ejector is fixed on and connected to a button.

4. The device as claimed in claim 2, wherein the ratchet connecting plug includes a receiving part for mounting the ejector therein.

5. The device as claimed in claim 4, wherein the ejector is fixed on and connected to a button.

6. The device as claimed in claim 2, wherein a clamping hole is disposed on each of two ends of the outer plate and is used for mounting the ratchet connecting plug.

7. The device as claimed in claim 2, wherein the outer plate is arranged with at least one fixing hole mounted with a fixing member; an insertion hole corresponding to the fixing hole is disposed on the inner plate; the fixing member penetrates the insertion hole of the inner plate to be fixed in the fixing hole of one of other outer plates.

8. The device as claimed in claim 2, wherein the inner plate is arranged with a locking hole; the first elastic part is clipped between the locking block and the locking hole.

9. The device as claimed in claim 8, wherein the outer plate is arranged with at least one fixing hole mounted with a fixing member; the fixing member penetrates the locking hole of the inner plate to be fixed in the fixing hole of one of other outer plates.

10. The device as claimed in claim 1, wherein a clamping hole is disposed on each of two ends of the outer plate and is used for mounting the ratchet connecting plug.

11. The device as claimed in claim 1, wherein the outer plate is arranged with at least one fixing hole mounted with a fixing member; an insertion hole corresponding to the fixing hole is disposed on the inner plate; the fixing member penetrates the insertion hole of the inner plate to be fixed in the fixing hole of one of other outer plates.

12. The device as claimed in claim 1, wherein the inner plate is set with a locking hole and the first elastic part is clipped between the locking block and the locking hole.

13. The device as claimed in claim 12, wherein the outer plate is arranged with at least one fixing hole mounted with a fixing member; the fixing member penetrates the locking hole of the inner plate to be fixed in the fixing hole of one of other outer plates.
